(19) United States
(12) Patent Application Publication
(10) Pub. No.: US 2026/0094336 A1
(43) Pub. Date: Apr. 2, 2026

(54) ANIMATING A VIRTUAL OBJECT

(71) Applicant: APPLE INC., Cupertino, CA (US)

(72) Inventors: Danvin Ruangchan, San Jose, CA (US); Eric G. Thivierge, Merchantville, NJ (US); John N. Nunes, San Francisco, CA (US); Jonathan Perron, Felton, CA (US); Jordan A. Cazamias, San Francisco, CA (US); Kenneth D. Zauderer, Cupertino, CA (US); Michael C. Evashevski, San Francisco, CA (US); Stephanie L. Biddle, Cupertino, CA (US)

(21) Appl. No.: 19/333,246

(22) Filed: Sep. 18, 2025

Related U.S. Application Data
(60) Provisional application No. 63/699,892, filed on Sep. 27, 2024.

(51) Int. Cl. G06T 13/00; G06F 3/04842

(52) U.S. Cl. CPC G06T 13/00; G06F 3/04842; G06T 2200/24

(57) ABSTRACT

A method includes obtaining a virtual object that is animatable. The method includes determining that an animation of the virtual object is a function of a value obtained from a first application programming interface (API) of a plurality of APIs available at the device. The method includes displaying the animation of the virtual object in accordance with the value obtained from the first API.

### CROSS-REFERENCE TO RELATED APPLICATIONS

This application claims priority to U.S. Provisional App. No. 63/699,892, filed on Sep. 27, 2024, which is hereby incorporated by reference in its entirety.

### TECHNICAL FIELD

The present disclosure generally relates to animating a virtual object.

### BACKGROUND

Some devices include a display. Some devices display virtual objects on the display. Creating virtual objects can be resource-intensive. Some virtual objects are static, and some virtual objects are animated. Making an animated virtual object tends to be resource-intensive for a content creator.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-1I are diagrams of an example environment in accordance with some implementations.

FIG. 2 is a block diagram of a system that animates an object in accordance with some implementations.

FIG. 3 is a flowchart representation of a method of automatically animating an object in accordance with some implementations.

FIG. 4 is a block diagram of a device that automatically animates an object in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for animating a virtual object. In some implementations, a device includes a display, one or more processors and a non-transitory memory. In various implementations, a method includes obtaining a virtual object that is animatable. In some implementations, the method includes determining that an animation of the virtual object is a function of a value obtained from a first application programming interface (API) of a plurality of APIs available at the device. In some implementations, the method includes displaying the animation of the virtual object in accordance with the value obtained from the first API.

In accordance with some implementations, a device includes one or more processors, a non-transitory memory, and one or more programs. In some implementations, the one or more programs are stored in the non-transitory memory and are executed by the one or more processors. In some implementations, the one or more programs include instructions for performing or causing performance of any of the methods described herein. In accordance with some implementations, a non-transitory computer readable storage medium has stored therein instructions that, when executed by one or more processors of a device, cause the device to perform or cause performance of any of the methods described herein. In accordance with some implementations, a device includes one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

A virtual object without animations is static and has relatively low utility. Animating the virtual object tends to be a resource-intensive operation. For example, a creator of the virtual object may have to manually associate an animation with the virtual object. Furthermore, associating a particular animation with a virtual object may make the virtual object unsuitable for some environments. For example, the same animation may not be relevant in different environments.

The present disclosure provides methods, systems, and/or devices for automatically animating a virtual object based on data obtained from an application programming interface (API) associated with the virtual object. A creator of a virtual object can associate a virtual object with certain APIs. When a device obtains the virtual object, the device detects the association of the virtual object with certain APIs. The device can obtain data from the APIs that are associated with the virtual object and animate the virtual object in accordance with the data obtained from the APIs that are associated with the virtual object.

As an example, a virtual object may be associated with a weather API. The device obtains weather data from a weather API and animates the virtual object in accordance with the weather data obtained from the weather API. As an example, if the weather data indicates that it is snowing, the device animates the virtual object such that virtual snow is falling on the virtual object and/or the virtual object is displayed in a frozen state (e.g., with virtual frost or virtual icicles forming on top of the virtual object).

As another example, a virtual object may be associated with a location API. The device obtains location data from a location API and animates the virtual object in accordance with the location data obtained from the location API. As an example, if the location data indicates that the device is located in a private location (e.g., the user's home), the device animates the virtual object in accordance with an animation designed for the private location (e.g., a cartwheel as a show of approval). In this example, if the location data indicates that the device is located in a public location (e.g., outside the user's home, for example, at a shopping mall), the device animates the virtual object in accordance with an animation designed for the public location (e.g., a nod as a show of approval).

As another example, a virtual object may be associated with a music API. The device obtains music data (e.g., now playing data) from a music API and animates the virtual object in accordance with music that is currently playing. As an example, if the music data indicates that the device is currently playing a workout playlist, the device animates the virtual object to perform a workout animation (e.g., pushups) and if the music data indicates that the device is currently playing a dance playlist, the device animates the virtual object to perform a dancing animation (e.g., twirling).

Automatically animating the virtual object based on API data reduces the need for a content creator to manually associate animations with the virtual object thereby conserving memory required for storing pre-authored animations. Furthermore, automatically animating virtual objects based on API data makes the animations more contextually relevant than pre-authored animations thereby increasing an engagement of the user with the device. Additionally, automatically animating virtual objects based on API data allows the device to adapt the virtual object's behavior based on a current context of the device or a user of the device thereby making the virtual object appear more realistic and responsive to the user's surroundings. Context-aware animations for virtual objects tends to increase device usage, user satisfaction and retention in extended reality (XR) content.

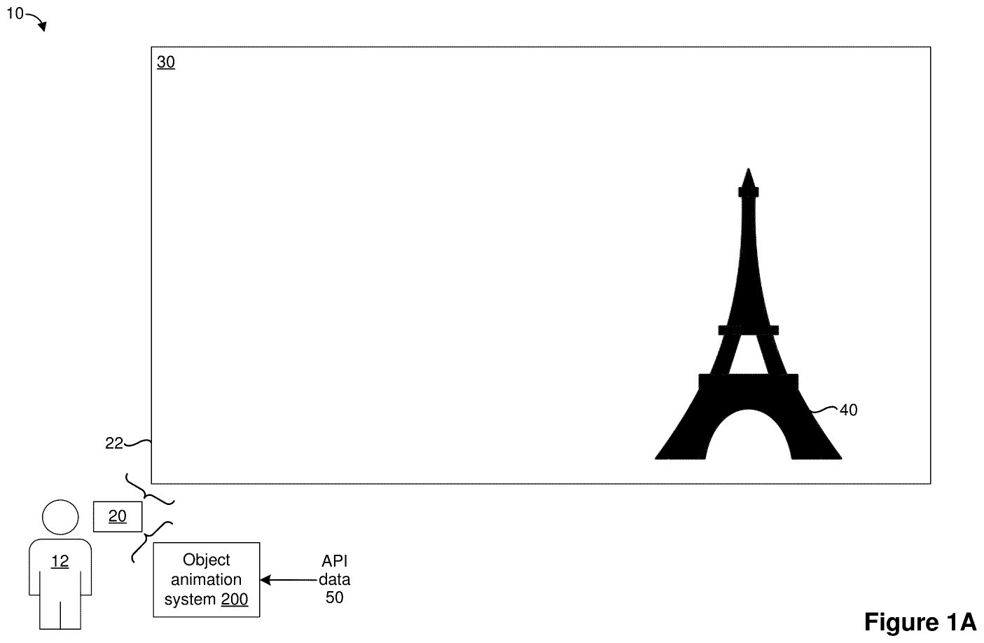

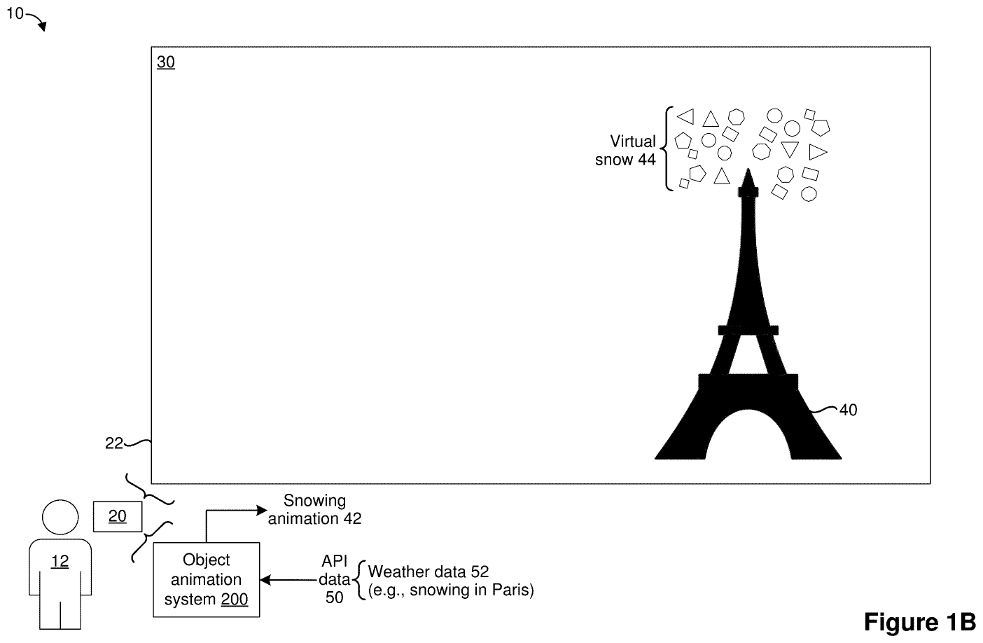

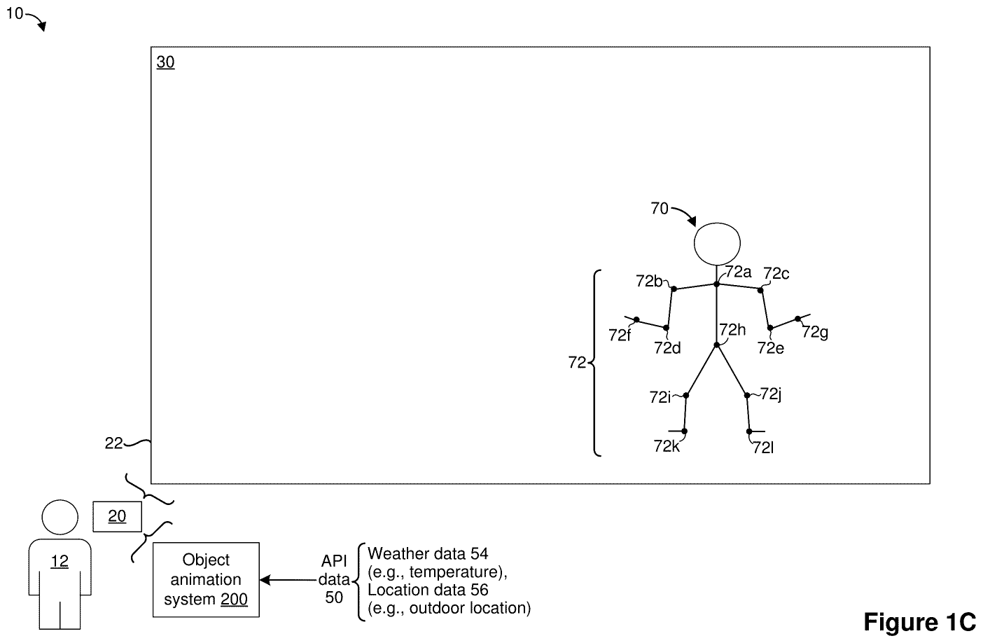

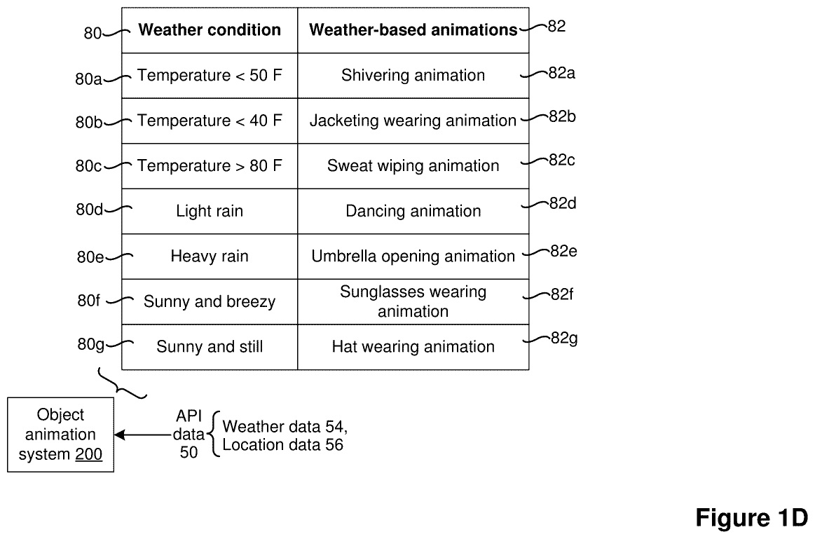

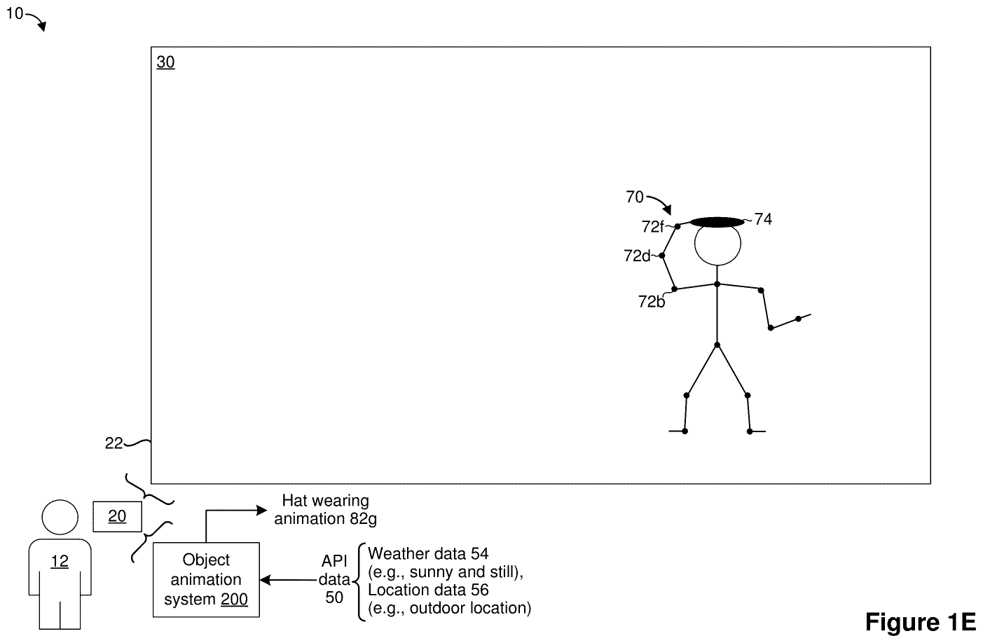

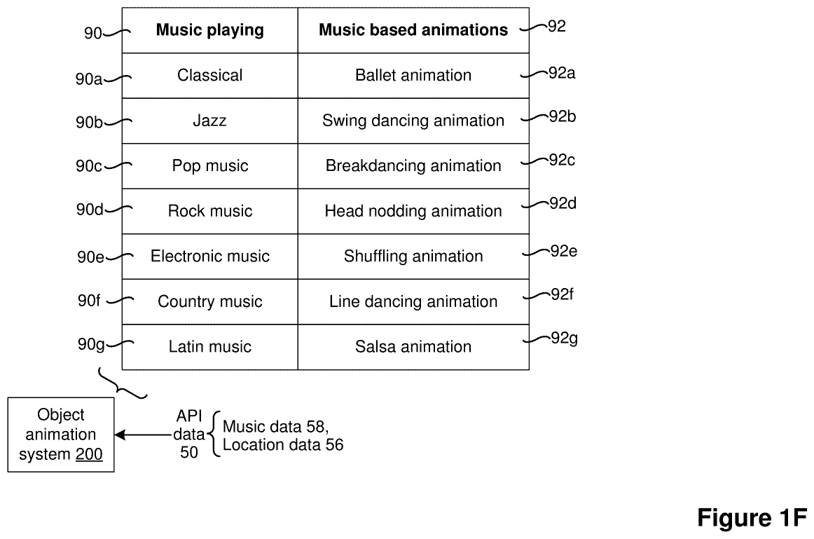

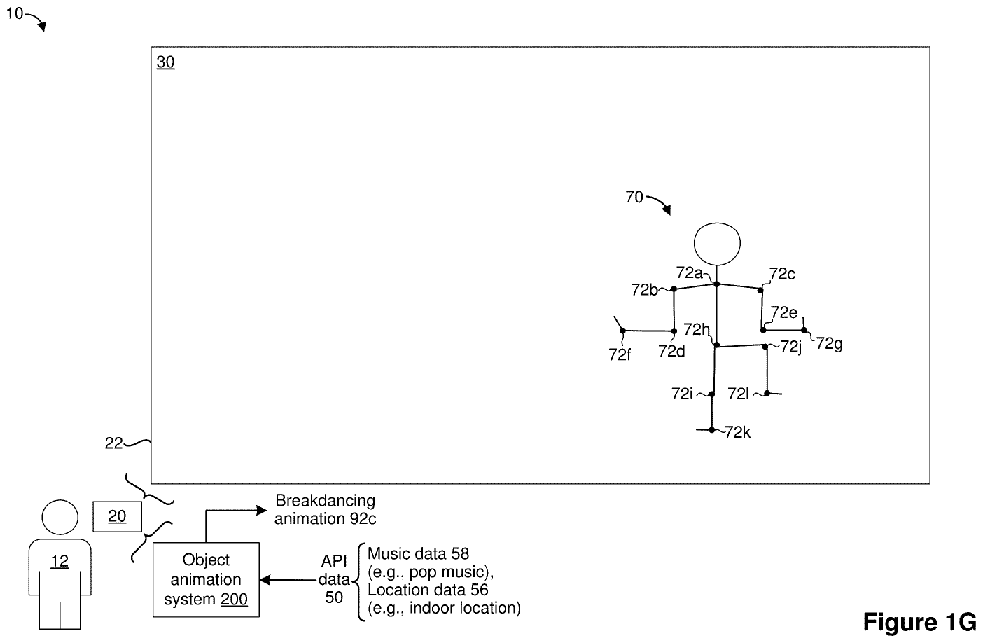

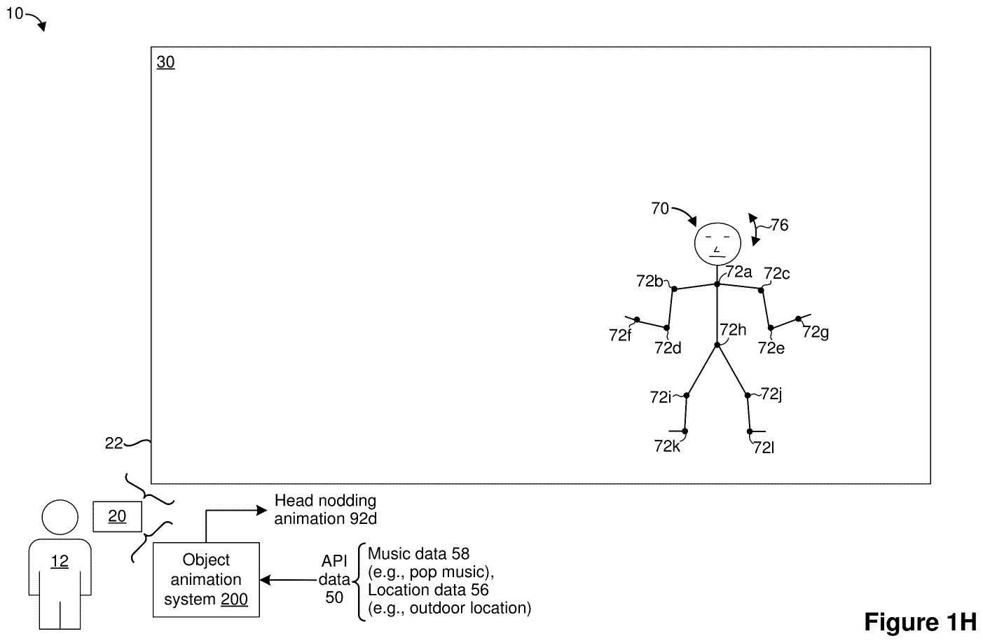

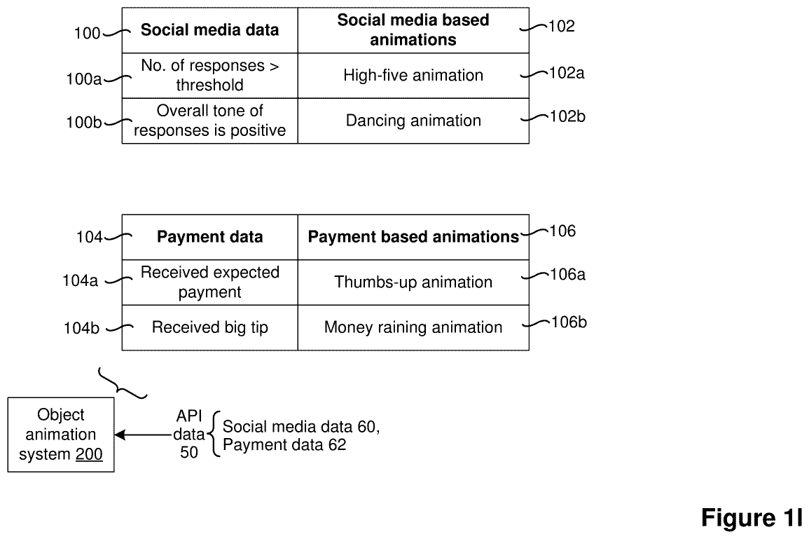

FIG. 1A is a diagram that illustrates an example physical environment 10 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. In various implementations, the physical environment 10 includes a user 12, an electronic device 20 (“device 20”, hereinafter for the sake of brevity) with a display 22, and an object animation system 200 for automatically animating virtual objects displayed on the display 22. In some implementations, the object animation system 200 resides at the device 20. Alternatively, in some implementations, the object animation system 200 resides at another device that is in electronic communication with the device 20. For example, the device 20 includes a head-mountable device (HMD) and the object animation system 200 resides at a smartphone that is wirelessly connected with the HMD.

In the example of FIG. 1A, the device 20 displays an extended reality (XR) environment 30. In some implementations, the XR environment 30 is a pass-through representation of the physical environment 10. Alternatively, in some implementations, the XR environment 30 is a virtual environment. In the example of FIG. 1A, the XR environment 30 includes a virtual tower 40. In some implementations, the device 20 presents a graphical user interface (GUI) that enables the user 12 to import the virtual tower 40 into the XR environment 30. For example, in some implementations, the device 20 displays an import button that the user 12 presses to trigger display of an object library with various virtual objects, and the user 12 selects the virtual tower 40 from the object library.

In various implementations, the virtual tower 40 is not pre-associated with animations. As such, the virtual tower 40 may be a static object. For example, a content creator that created the virtual tower 40 did not create an animation for the virtual tower or associate the virtual tower 40 with existing animations from an animation library. In various implementations, the device 20 and/or the object animation system 200 determines to animate the virtual tower 40 even though the virtual tower 40 is not associated with animations. The object animation system 200 obtains application programming interface (API) data 50 from a set of one or more APIs and animates the virtual tower 40 based on the API data 50. Animating the virtual tower 40 transforms the virtual tower 40 from a static object to a dynamic object that responds to changing conditions in the physical environment 10 thereby becoming more relevant to a current context of the device 20 or the user 12.

In the example of FIG. 1A, the virtual tower 40 represents a physical tower at a geographical location that is remote from the physical environment 10. For example, the virtual tower 40 represents the Eiffel tower in Paris and the device 20 is in the United States. In some implementations, the API data 50 provides information regarding the geographical location of the physical tower that the virtual tower 40 represents. For example, the API data 50 provides information related to Paris. In such implementations, the object animation system 200 animates the virtual tower 40 based on information regarding the geographical location of the physical tower instead of a current geographical location of the device 20 (e.g., based on information related to Paris and not the United States where the device 20 is located).

Referring to FIG. 1B, the API data 50 includes weather data 52 from a weather API. In the example of FIG. 1B, the weather data 52 indicates that it is snowing in Paris. In response to the weather data 52 indicating that it is snowing in Paris, the object animation system 200 presents a snowing animation 42 by displaying virtual snow 44 falling on top of the virtual tower 40. Displaying the virtual snow 44 tends to increase an engagement of the user 12 with the virtual tower 40. Displaying the virtual snow 44 reduces the need for the user 12 to lookup the weather in Paris thereby conserving resources associated with performing a weather search for Paris.

In some implementations, the object animation system 200 further animates the virtual tower 40 based on the API data 50. For example, if the weather data 52 indicates a temperature value that is less than a threshold temperature, the object animation system 200 displays virtual frost forming on the virtual tower 40 by applying a frost forming animation on the virtual tower 40. As another example, the object animation system 200 displays virtual icicles forming on the virtual tower 40 by applying an icicle forming animation to the virtual tower 40 when the weather data 52 indicates a temperature value that is below a threshold temperature and melting snow or ice refreezes while dripping from the virtual tower 40.

In some implementations, the object animation system 200 animates the virtual tower 40 based on API data 50 from other APIs. For example, the object animation system 200 overlays a virtual lighting animation (e.g., a lightshow) on top of the virtual tower 40 based on music data from a music API. In some implementations, the music data indicates music that the device 20 is currently playing and the object animation system 200 varies a parameter of the virtual lighting animation based on the music that the device 20 is currently playing. For example, a blinking rate, a color and/or an intensity of the lights overlaid on the virtual tower 40 is a function of an audio characteristic of the music that the device is currently playing. In some examples, the lights get brighter as the music gets louder, the lights dim as the music softens, the lights blink faster as the music beat speeds up, and the lights blink slower as the music beat slows down.

FIG. 1C displays a virtual character 70 with various joints 72. In the example of FIG. 1C, the joints 72 include a neck joint 72a, a left shoulder joint 72b, a right shoulder joint 72c, a left elbow joint 72d, a right elbow joint 72e, a left wrist joint 72e, a right wrist joint 72g, a hip joint 72h, a left knee joint 72i, a right knee joint 72j, a left ankle joint 72k and a right ankle joint 72l. The object animation system 200 detects the joints 72 and determines that at least some of the API data 50 can be used to manipulate the joints 72.

In the example of FIG. 1C, the object animation system 200 determines that weather data 54 from the weather API and location data 56 from a location API can be used to manipulate the joints 72. In some implementations, the weather data 54 includes a temperature value, a precipitation value, a wind speed and/or an indication of whether it is sunny or cloudy. In some implementations, the location data 56 includes a current geographical location of the device 20. In some implementations, the location data 56 indicates whether the device 20 is located indoors or outdoors.

Referring to FIG. 1D, in some implementations, the object animation system 200 detects a weather condition 80 based on the weather data 54 and triggers the virtual character 70 to perform a corresponding animation 82 (e.g., a weather-based animation). As an example, the object animation system 200 determines that a first weather condition 80a is satisfied when the weather data 54 indicates that a temperature of the physical environment is less than 50 degrees Fahrenheit. In response to determining that the first weather condition 80a is satisfied, the object animation system 200 triggers the virtual character 70 to perform a shivering animation 82a in order to provide an appearance that the virtual character 70 is shivering as a result of the relatively cold environment.

As another example, the object animation system 200 determines that a second weather condition 80b is satisfied when the weather data 54 indicates that a temperature of the physical environment is less than 40 degrees Fahrenheit. In response to determining that the second weather condition 80b is satisfied, the object animation system 200 triggers the virtual character 70 to perform a jacket wearing animation 82b in order to provide an appearance that the virtual character 70 is putting on a virtual jacket to protect itself from the relatively cold environment.

As another example, the object animation system 200 determines that a third weather condition 80c is satisfied when the weather data 54 indicates that a temperature of the physical environment is greater than 80 degrees Fahrenheit. In response to determining that the third weather condition 80c is satisfied, the object animation system 200 triggers the virtual character 70 to perform a sweat wiping animation 82c in order to provide an appearance that the virtual character 70 is feeling hot and wiping virtual sweat off its virtual forehead.

As another example, the object animation system 200 determines that a fourth weather condition 80d is satisfied when the weather data 54 indicates that there is light rain in the physical environment (e.g., a drizzle, for example, a precipitation value is less than a threshold). In response to determining that the fourth weather condition 80d is satisfied, the object animation system 200 triggers the virtual character 70 to perform a dancing animation 82d in order to provide an appearance that the virtual character 70 is dancing and enjoying the light rain.

As another example, the object animation system 200 determines that a fifth weather condition 80e is satisfied when the weather data 54 indicates that there is heavy rain in the physical environment (e.g., a downpour, for example, a precipitation value is greater than a threshold). In response to determining that the fifth weather condition 80e is satisfied, the object animation system 200 triggers the virtual character 70 to perform an umbrella opening animation 82e in order to provide an appearance that the virtual character 70 is opening a virtual umbrella to protect itself from the heavy rain.

As another example, the object animation system 200 determines that a sixth weather condition 80f is satisfied when the weather data 54 indicates that it is sunny and breezy in the physical environment (e.g., an ambient light value is greater than an ambient light threshold and a wind speed is greater than a wind speed threshold). In response to determining that the sixth weather condition 80f is satisfied, the object animation system 200 triggers the virtual character 70 to perform a sunglasses wearing animation 82e in order to provide an appearance that the virtual character 70 is putting on a pair of virtual sunglasses to protect itself from the bright sun.

As another example, the object animation system 200 determines that a seventh weather condition 80g is satisfied when the weather data 54 indicates that it is sunny and relatively still (e.g., ambient light value is greater than an ambient light threshold and a wind speed is less than a wind speed threshold). In response to determining that the seventh weather condition 80g is satisfied, the object animation system 200 triggers the virtual character 70 to perform a hat wearing animation 82g in order to provide an appearance that the virtual character 70 is putting on a virtual hat in order to protect itself from the bright sun.

Referring to the example of the sixth weather condition 80f, a virtual hat may fly away when it is breezy whereas virtual sunglasses will likely stay on even when it is breezy. Hence, performing the sunglasses wearing animation 82f instead of the hat wearing animation 82g when it is breezy is more realistic (e.g., similar to what the user 12 may do). By contrast, in the example of the seventh weather condition 80g, performing the hat wearing animation 82g may appear realistic because a hat is less likely to fly away when the wind is relatively calm.

Referring to FIG. 1E, the weather data 54 indicates that it is sunny and still, and the location data 56 indicates that the device 20 is located outdoors. In the example of FIG. 1E, the weather data 54 satisfies the seventh weather condition 80g shown in FIG. 1D. As such, in response to determining that the weather data 54 satisfies the seventh weather condition 80g, the object animation system 200 animates the virtual character 70 in accordance with the hat wearing animation 82g. As shown in FIG. 1E, the virtual character 70 puts on a virtual hat 74. In some implementations, the object animation system 200 instructs a motion controller to generate torque values for the left shoulder joint 72b, the left elbow joint 72d and the left wrist joint 72f. The device 20 applies the generated torque values to the left shoulder joint 72b, the left elbow joint 72d and the left wrist joint 72f in order to provide an appearance that the virtual character 70 is using its left arm to put on the virtual hat 74.

Referring to FIG. 1F, in some implementations, the API data 50 includes music data 58 that indicates a type of music currently playing on the device 20. In some implementations, the object animation system 200 detects a music condition 90 based on the music data 58 and triggers the virtual character 70 to perform a corresponding animation 92 (e.g., a music-based animation). As an example, the object animation system 200 determines that a first musical condition 90a is satisfied when the music data 58 indicates that the device 20 is currently playing classical music (e.g., classical compositions by well renowned composers). In response to determining that the first musical condition 90a is satisfied, the object animation system 200 triggers the virtual character 70 to perform a ballet animation 92a in order to provide an appearance that the virtual character 70 is performing a ballet dance move (e.g., a combination of pirouettes, arabesques and pliés).

As another example, the object animation system 200 determines that a second musical condition 90b is satisfied when the music data 58 indicates that the device 20 is currently playing jazz music (e.g., swing jazz or big band music). In response to determining that the second musical condition 90b is satisfied, the object animation system 200 triggers the virtual character 70 to perform a swing dancing animation 92b in order to provide an appearance that the virtual character 70 is swing dancing (e.g., performing a combination of jumps, spins and lifts).

As another example, the object animation system 200 determines that a third musical condition 90c is satisfied when the music data 58 indicates that the device 20 is currently playing pop music (e.g., beat-driven pop or hip-hop tracks). In response to determining that the third musical condition 90c is satisfied, the object animation system 200 triggers the virtual character 70 to perform a breakdancing animation 92c in order to provide an appearance that the virtual character 70 is breakdancing (e.g., performing popping, locking and breaking moves with fast arm movement and footwork).

As another example, the object animation system 200 determines that a fourth musical condition 90d is satisfied when the music data 58 indicates that the device 20 is currently playing rock music (e.g., classic rock, heavy rock or metal music). In response to determining that the fourth musical condition 90d is satisfied, the object animation system 200 triggers the virtual character 70 to perform a head nodding animation 92d in order to provide an appearance that the virtual character 70 is nodding its head.

As another example, the object animation system 200 determines that a fifth musical condition 90e is satisfied when the music data 58 indicates that the device 20 is currently playing electronic music (e.g., music with fast beats). In response to determining that the fifth musical condition 90e is satisfied, the object animation system 200 triggers the virtual character 70 to perform a shuffling animation 92e in order to provide an appearance that the virtual character 70 is shuffling (e.g., performing quick heel-toe movements and sliding steps).

As another example, the object animation system 200 determines that a sixth musical condition 90f is satisfied when the music data 58 indicates that the device 20 is currently playing country music. In response to determining that the sixth musical condition 90f is satisfied, the object animation system 200 triggers the virtual character 70 to perform a line dancing animation 92f in order to provide an appearance that the virtual character 70 is line dancing (e.g., providing an appearance that the virtual character 70 is part of a line or a group and performing synchronized steps).

As another example, the object animation system 200 determines that a seventh musical condition 90g is satisfied when the music data 58 indicates that the device 20 is currently playing Latin music. In response to determining that the seventh musical condition 90g is satisfied, the object animation system 200 triggers the virtual character 70 to perform a salsa animation 92g in order to provide an appearance that the virtual character 70 is performing salsa (e.g., doing quick moves with intricate footwork including spins and hip movements).

In various implementations, in response to selecting one of the animations 92, the object animation system 200 instructs a motion controller to generate torque values for the joints 72 of the virtual character. As an example, the motion controller generates a first set of torque values for the ballet animation 92a. In this example, when the first set of torque values are applied to the joints 72 of the virtual character 70, the virtual character 70 appears to be performing a ballet move. As another example, the motion controller generates a second set of torque values for the swing dancing animation 92b. In this example, when the second set of torque values are applied to the joints 72 of the virtual character 70, the virtual character 70 appears to be swing dancing.

In some implementations, the object animation system 200 triggers the virtual character 70 to perform the animations 92 when the device 20 is located at a first type of location (e.g., indoors, for example, at a private location such as a home of the user 12). In some implementations, the object animation system 200 triggers the virtual character 70 to perform modified versions of the animations 92 when the device 20 is located at a second type of location that is different from the first type of location (e.g., outdoors, for example, in a public location such as a park or a playground). For example, the object animation system 200 forgoes footwork associated with the animations 92 by not animating the knee joints 72i and 72j, and the ankle joints 72k and 72l of the virtual character 70 when the device 20 is in a public setting.

Referring to FIG. 1G, the music data 58 indicates that the device 20 is currently playing pop music. As shown in FIG. 1F, playing pop music satisfies the third music condition 90c. In response to determining that the third music condition 90c is satisfied, the object animation system 200 selects the breakdancing animation 92c. A motion controller generate torque values for the joints 72 to exhibit the breakdancing animation 92c. The torque values are applied to the joints 72 in order to provide an appearance that the virtual character 70 is breakdancing in accordance with the breakdancing animation 92c.

Referring to FIG. 1H, in some implementations, the object animation system 200 selects the animation based further on the location data 56. In the example of FIG. 1G, the location data 56 indicates that the device 20 is located indoors. In some implementations, the object animation system 200 selects the animations 92 shown in FIG. 1F when the device 20 is located indoors. In some implementations, the object animation system 200 selects different animations when the device 20 is located outdoors. As shown in FIG. 1H, in some implementations, the object animation system 200 selects the head nodding animation 92d when the device 20 is located outdoors regardless of which type of music the device 20 is playing. As indicated by a bi-directional arrow adjacent to a head of the virtual character 70, the virtual character is performing head nodding 76 in accordance with the head nodding animation 92d. Varying the animation based on the location of the device 20 results in a more realistic behavior for the virtual character 70 because the user 12 likely responds to music differently based on where the user 12 is listening to the music. As an example, the user 12 likely performs a head nodding motion when listening to pop music in an outdoor park. In this example, the object animation system 200 selects the head nodding animation 92d when the device 20 is located outdoors and the device 20 is playing pop music in order to mimic a likely behavior of the user 12.

Referring to FIG. 1I, in some implementations, the API data 50 includes social media data 60 that indicates social media activity related to the user 12. In some implementations, the object animation system 200 detects a social media condition 100 based on the social media data 60 and triggers the virtual character 70 to perform a corresponding animation 102. As an example, the object animation system 200 determines that a first social media condition 100a is satisfied when the social media data 60 indicates that a number of posts related to the user 12 exceeds a threshold number of posts (e.g., a number of congratulatory responses to a promotion that the user 12 recently received exceeds 25). In response to determining that the first social media condition 100a is satisfied, the object animation system 200 triggers the virtual character 70 to perform a high-five animation 102a in order to provide an appearance that the virtual character 70 is doing a high-five with the user 12.

As another example, the object animation system 200 determines that a second social media condition 100b is satisfied when the social media data 60 indicates that an overall tone of responses to a user post is positive (e.g., more than a threshold number of other users approved of the user post). In response to determining that the second social media condition 100b is satisfied, the object animation system 200 triggers the virtual character 70 to perform a dancing animation 102b in order to provide an appearance that the virtual character 70 is happy about the positive tone of the responses.

In some implementations, the API data 50 includes payment data 62 that indicates payment activity related to the user 12. In some implementations, the object animation system 200 detects a payment condition 104 based on the payment data 62 and triggers the virtual character 70 to perform a corresponding animation 106. As an example, the object animation system 200 determines that a first payment condition 104a is satisfied when the payment data 62 indicates that the user 12 has received an expected payment (e.g., payment for an outstanding invoice or a scheduled salary payment). In response to determining that the first payment condition 104a is satisfied, the object animation system 200 triggers the virtual character 70 to perform a thumbs-up animation 106a in order to provide an appearance that the virtual character 70 is giving a thumbs-up to the user 12.

As another example, the object animation system 200 determines that a second payment condition 104b is satisfied when the payment data 62 indicates that the user 12 received a big tip (e.g., a payment that exceeded an expected payment). In response to determining that the second payment condition 104b is satisfied, the object animation system 200 performs a money raining animation 106b by displaying virtual money falling onto the XR environment 30.

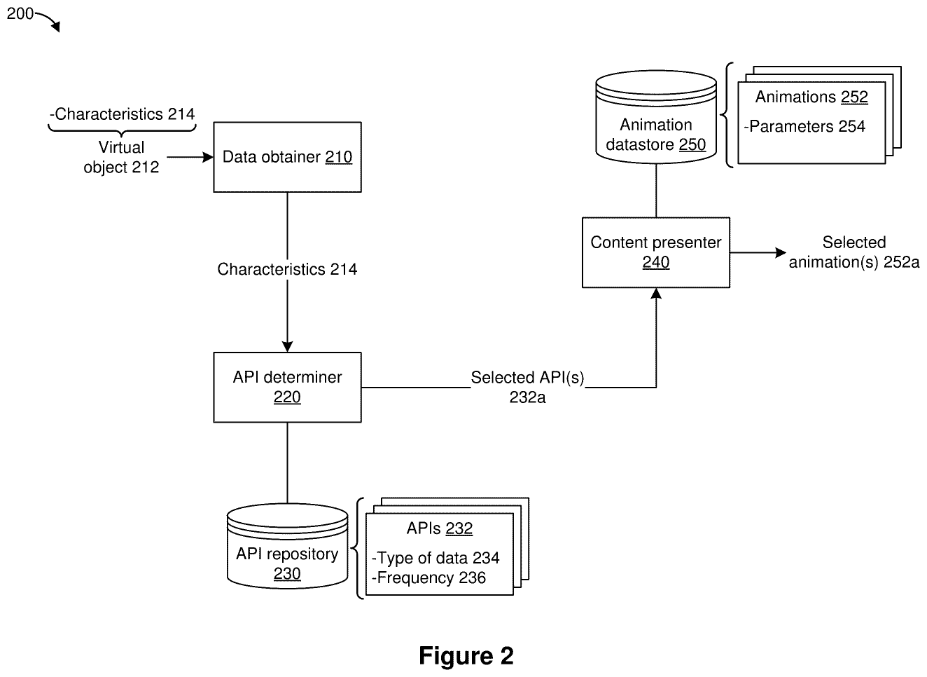

FIG. 2 is a block diagram of the object animation system 200 in accordance with some implementations. In some implementations, the object animation system 200 includes a data obtainer 210, an API determiner 220, an API repository 230 that stores information regarding various APIs 232, a content presenter 240 and an animation datastore 250 that stores information regarding various animations 252.

In various implementations, the data obtainer 210 obtains a virtual object 212 that is associated with a set of one or more characteristics 214. In some implementations, the data obtainer 210 receives the virtual object 212 from a content generator that generated the virtual object 212. For example, the data obtainer 210 receives the virtual object 212 from a content creator (e.g., a human operator) that created the virtual object 212. Alternatively, in some examples, the virtual object 212 includes a machine-generated object (e.g., the virtual object 212 is generated by an image generation tool based on a text prompt). In some implementations, the virtual object 212 is a two-dimensional (2D) object. In some implementations, the virtual object 212 is a three-dimensional (3D) object. In some implementations, the virtual object 212 is referred to as a widget (e.g., a 3D widget).

In some implementations, the characteristics 214 of the virtual object 212 indicate a visual characteristic of the virtual object 212. For example, the characteristics 214 indicate a color, a shape and/or a size of the virtual object 212. In some implementations, the characteristics 214 indicate a behavioral characteristic of the virtual object 212. For example, the characteristics 214 indicate a placement affinity of the virtual object 212 (e.g., types of locations where the virtual object 212 can be placed, for example, indoor locations or outdoor locations). In some implementations, the characteristics 214 indicate a mesh of the virtual object 212. In some implementations, the characteristics 214 include a skeleton of the virtual object 212 with various joints (e.g., the joints 72 shown in FIG. 1C).

In some implementations, some of the characteristics 214 are associated with an animatable flag indicating that the flagged characteristics 214 can be animated. For example, a position characteristic of the virtual object 212 may be associated with an animatable flag indicating that the position of the virtual object 212 can be changed based on API data. As another example, a rotation characteristic (e.g., a pitch, a yaw and/or a roll) of the virtual object 212 may be associated with an animatable flag indicating that the virtual object 212 can be rotated based on API data. As another example, a color characteristic may be associated with an animatable flag indicating that the color of the virtual object 212 can be changed based on API data. As another example, a texture characteristic of the virtual object 212 may be associated with an animatable flag indicating that the texture of the virtual object 212 can be changed based on API data. As another example, a visibility characteristic of the virtual object 212 may be associated with an animatable flag indicating that the visibility of the virtual object 212 can be changed based on API data. As another example, a facial expression of a virtual character may be associated with an animatable flag indicating that the facial expression of the virtual character can be changed based on API data. As another example, certain joints of a virtual character may be associated with an animatable flag indicating that the joints can be moved based on API data.

In some implementations, the characteristics 214 indicate types of API data that can be used to animate the virtual object 212. For example, a content generator that generated the virtual object 212 associates metadata with the virtual object 212. In this example, the metadata indicates whether or not the virtual object 212 can be animated based on weather data from a weather API, location data from a location API, music data from a music API, social media data from a social media API and payment data from a payment API. As an example, metadata associated with the virtual object 212 may indicate that a movement of the virtual object 212 can be animated based on weather data from the weather API. As another example, metadata associated with a virtual character may indicate that a facial expression of the virtual character can be varied based on whether the weather data indicates a sunny condition or a cloudy condition.

In some implementations, the data obtainer 210 obtains the virtual object 212 via a graphical user interface (GUI) that allows the user 12 to upload the virtual object 212. In some implementations, the GUI allows the user 12 to specify which portions of the virtual object 212 are to be animated and which portions of the virtual object 212 are not to be animated. As an example, referring to FIG. 1A, the user 12 may specify that the four legs of the virtual tower 40 can be animated to move independently similar to limbs of a quadrupedal entity such as a deer or an elephant. As another example, referring to FIG. 1A, the user 12 may specify that a visual appearance (e.g., a color, a brightness, etc.) of the virtual tower 40 can be changed based on music data from a music API, weather data from a weather API, etc.

In various implementations, the API repository 230 stores information regarding various APIs 232. For example, for each of the APIs 232, the API repository 230 indicates a type of data 234 that the API 232 provides and a frequency 236 at which the API 232 provides the data. As an example, the API repository 230 indicates that the weather API provides current weather data (e.g., temperature value, humidity value, wind speed, visibility, precipitation value, atmospheric pressure value and/or UV index value), weather forecasts (e.g., expected future values), historical weather data (e.g., previous weather values), weather alerts, etc. every 5 minutes. As another example, the API repository 230 indicates that the music API provides information regarding which music item is currently playing. As another example, the API repository 230 indicates that the social media API provides information regarding social media activity related to a social media account of the user.

In some implementations, the API determiner 220 identifies a set of one or more selected APIs 232a from the APIs 232 based on the characteristics 214 of the virtual object 212 and the type of data 234 that the APIs 232 provide. In some implementations, the API determiner 220 identifies the selected API(s) 232a based on a match between the type of data 234 that the selected API(s) 232a provide and the type of API data that can be used to animate the virtual object 212. As an example, if the characteristics 214 include a facial expression of a virtual character that can be animated based on weather data, the selected APIs 232a include the weather API. As another example, if the characteristics 214 include a set of joints that can be manipulated based on now playing data from a music API, the selected APIs 232a include the music API. As another example, if the characteristics 214 indicate a location of a physical object represented by the virtual object 212, the selected APIs 232a include APIs that provide information regarding the location of the physical object (e.g., the weather API to provide weather at the location of the physical object, the social media API to provide a sentiment at the location of the physical object, etc.).

In various implementations, the animation datastore 250 stores information regarding the animations 252. In some implementations, the animations 252 are associated with various parameters 254. As an example, the parameters 254 may include a speed at which a particular animation 252 is played. As another example, the parameters 254 include a time duration for playing a particular animation 252. As another example, the parameters 254 include a smoothness at which a particular animation 252 is played.

In some implementations, the content presenter 240 selects a particular animation 252a (“selected animation(s) 252a”, hereinafter for the sake of brevity) from the animations 252 based on the characteristics 214 and the selected API(s) 232a. In some implementations, the selected animation(s) 252a are a function of the type of data 234 provided by the selected API(s) 232a. As an example, if the weather API indicates that it is snowing then the selected animation(s) 252a include a snowing animation (e.g., the snowing animation 42 shown in FIG. 1B). As another example, if the music API indicates that the device is currently playing a particular type of music and the characteristics 214 include moveable joints, the selected animation(s) 252a includes a dancing animation (e.g., one or more of the animations 92 shown in FIG. 1F). As another example, if the selected API(s) 232a include the social media API, the selected animation(s) 252a may include an animation that is based on social media data provided by the social media API (e.g., the animations 102 shown in FIG. 1I). As another example, if the selected API(s) 232a includes the payment API, the selected animation(s) 252a include an animation that is based on payment data provided by the payment API (e.g., the animations 106 shown in FIG. 1I).

In various implementations, the content presenter 240 provides the selected animation(s) 252a to a rendering and display pipeline. In some implementations, the content presenter 240 provides the selected animation(s) 252a to a motion controller that generates torque values for respective joints of the virtual object.

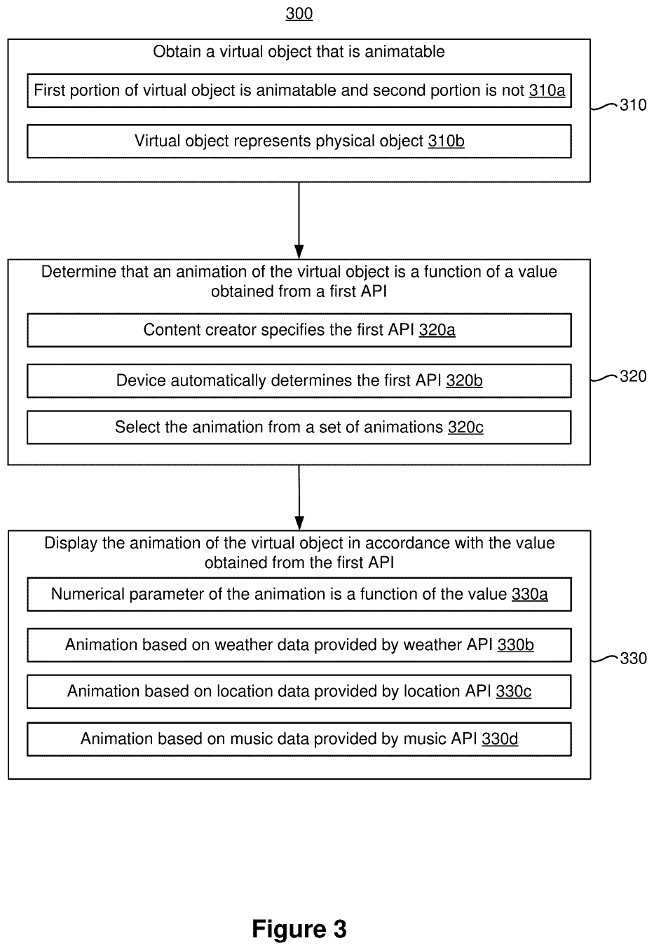

FIG. 3 is a flowchart representation of a method 300 for animating a virtual object based on API data. In various implementations, the method 300 is performed by a device including a display, a non-transitory memory and one or more processors coupled with the display and the non-transitory memory (e.g., the device 20 shown in FIGS. 1A-1H and/or the object animation system 200 shown in FIGS. 1A-2). In some implementations, the method 300 is performed by processing logic, including hardware, firmware, software, or a combination thereof. In some implementations, the method 300 is performed by a processor executing code stored in a non-transitory computer-readable medium (e.g., a memory).

As represented by block 310, in some implementations, the method 300 includes obtaining a virtual object that is animatable. For example, as shown in FIG. 2, the data obtainer 210 obtains the virtual object 212. In some implementations, the device displays a GUI that allows a user to import the virtual object, or generate the virtual object based on a user input such as a prompt or an image.

As represented by block 310a, in some implementations, the virtual object includes various portions. As an example, the virtual object includes a first portion that is animatable and a second portion that is not animatable. In some implementations, a content creator that created the virtual object identifies the first portion as being animatable and the second portion as not being animatable. In some implementations, the device automatically determines that the first portion is animatable as a result of being connected to a body of the virtual object via a moving joint. More generally, in various implementations, the device performs semantic segmentation in order to identify portions of the virtual object that are animatable (e.g., can be animated) and portions of the virtual object that are not animatable (e.g., cannot be animated in a realistic manner). For example, referring to FIG. 1C, the device 20 identifies that the virtual character 70 can be animated by generating torque values for the joints 72 of the virtual character 70.

As represented by block 310b, in some implementations, the virtual object represents a physical object. For example, the virtual object represents the Eiffel Tower. In some implementations, the method 300 includes determining that the device is located at a first location while the physical object represented by the virtual object is located at a second location that is different from the first location. For example, the device is located in California and the virtual object represents the Eiffel Tower in Paris. In this example, the device determines to animate the virtual object based on API data related to the second location of the physical object represented by the virtual object. By utilizing API data related to the location of the physical object, the device functionality is improved by dynamically and contextually rendering animations that are relevant to the physical environment of the represented object, regardless of the device's current location. For example, as shown in FIG. 1B, the device 20 uses the weather data 52 associated with Paris such that, if it is snowing in Paris, the virtual snow 44 is displayed falling on the virtual tower 40 representing the Eiffel Tower.

As represented by block 320, in some implementations, the method 300 includes determining that an animation of the virtual object is a function of a value obtained from a first application programming interface (API) of a plurality of APIs available at the device. For example, as shown in FIG. 2, the API determiner 220 identifies that the selected API(s) 232a can be used to animate the virtual object 212. Determining which API data is relevant for animating the virtual object tends to improve a functionality of the device by efficiently processing and rendering animations that are contextually accurate and relevant to current conditions. For example, as shown in FIG. 1B, the object animation system 200 determines to display the snowing animation 42 based on a value indicated by the weather data 52. Dynamically selecting and applying appropriate animations in real time improves a functionality of the device by increasing a responsiveness and adaptability of the device's graphical rendering capabilities. For example, the device is able to present virtual content that responds to and/or adapts to a current context of the device or a user of the device.

As represented by block 320a, in some implementations, the method 300 includes identifying the first API based on the virtual object. For example, the virtual object is associated with metadata specifying that data reported by the first API is to be used to animate the virtual object. As an example, the virtual tower 40 shown in FIGS. 1A and 1B may be associated with metadata specifying that weather data from a weather API can be used to display weather-related animations. As another example, the virtual character 70 shown in FIG. 1C may be associated with metadata specifying that weather data from a weather API can be used to check for the weather conditions 80 shown in FIG. 1D and animate the virtual character 70 based on the corresponding animations 82. As another example, the metadata associated with the virtual character 70 may further specify that music data from a music API can be used to perform the animations 92 shown in FIG. 1F. As another example, the metadata associated with the virtual character 70 may further specify that social media data from a social media API can be used to perform the animations 102 shown in FIG. 1I. As another example, the metadata associated with the virtual character 70 may further specify that payment data from a payment API can be used to perform the animations 106 shown in FIG. 1I.

As represented by block 320b, in some implementations, the method 300 includes automatically identifying the first API by identifying a characteristic of the virtual object. Advantageously, automatically identifying the first API enables the device to dynamically determine the most relevant API for animation thereby making efficient use of computational resources and reducing the need for manual configuration of the virtual object via user inputs. In some implementations, the method 300 includes identifying the first API based on a shape of the virtual object. For example, the method 200 includes selecting the weather API in response to the shape of the virtual object being similar to a monument. As another example, the device selects the music API in response to the shape of the virtual object being similar to an animate physical object (e.g., in response to the virtual object representing a living entity such as a person or an animal).

In some implementations, the method 300 includes identifying the first API based on components of the virtual object. For example, the method 300 includes selecting the music API and/or the payment API in response to the components including a moveable component such as a rotating joint or a moving limb. Advantageously, the device uses semantic segmentation to recognize functional elements and select APIs that provide data for animating the functional elements thereby enhancing responsiveness and relevance of the virtual object.

In some implementations, the method 300 includes identifying the first API based on a physical object that the virtual object represents. For example, selecting the social media API in response to the physical object trending on a social media platform. In some implementations, the method 300 includes identifying the first API based on a placement affinity of the virtual object. For example, selecting the weather API based on an outdoor placement affinity. In some implementations, the method 300 includes identifying the first API based on a joint placement of the virtual object. For example, selecting the music API based on the joints allowing for dancing movement responsive to different types of music genres.

In some implementations, the method 300 includes determining a type of data associated with changing the identified characteristic. For example, the method 300 includes determining whether a value of the characteristic can be changed based on readily accessible API data such as weather, location, or music data. In some implementations, the method 300 includes determining that the first API provides the type of data associated with changing the characteristic of the virtual object. For example, if the virtual object has an outdoor placement affinity, the method 300 includes selecting a weather API that provides weather data for configuring a weather-related animation. As another example, if the virtual object includes moveable joints, the method 300 includes selecting a music API that provides music data for configuring a dancing animation.

As represented by block 320c, in some implementations, the method 300 includes selecting the animation from a plurality of animations based on the value obtained from the first API. For example, the method 300 includes selecting a workout animation when the value indicates that the device is currently playing a workout playlist. As another example, the method 300 includes selecting a dancing animation when the value indicates that the device is currently playing a dance playlist. Utilizing API data to select a particular animation allows for a scalable animation system that can accommodate a wide variety of inputs and conditions. The device can support numerous animations without hard-coding each scenario, enabling greater flexibility in updating or adding new animations as new data types or APIs become available. By automatically selecting animations based on API values, the device reduces time and computational resources associated with determining which animation to play. For example, the device need not wait for a user input specifying which animation to play in a given scenario. Hence, selecting animations based on API data tends to reduce latency thereby enhancing a functionality of the device and improving user experience. In some implementations, the device caches or pre-fetches likely animations based on expected API data (e.g., based on trends or patterns) further reducing latency.

As represented by block 330, in some implementations, the method 300 includes displaying the animation of the virtual object in accordance with the value obtained from the first API. For example, as shown in FIG. 1B, the device 20 displays the snowing animation 42 based on the weather data 52. As another example, as shown in FIG. 1E, the device 20 displays the hat wearing animation 82g in response to the weather data 54 indicating a sunny condition and the location data 56 indicating an outdoor location. Animating the virtual object tends to improve user engagement by delivering dynamic, context-aware content that adapts to real-time data. Presenting content that is more engaging increases a utility of the device. Automatically animating the virtual object tends to reduce latency by reducing the need for user inputs that specify how to animate the virtual object. Animating the virtual object based on API data is more flexible than associating a particular animation with the virtual object because the virtual object can exhibit different animations as changing API data indicates contextual changes.

As represented by block 330a, in some implementations, the method 300 includes setting a numerical parameter of the animation based on a function of the value obtained from the first API. In some implementations, the method 300 includes setting a speed of the animation based on the value provided by the first API. For example, referring to FIG. 1B, a speed at which the virtual snow 44 is falling is based on a precipitation value indicated by the weather data 52. In some implementations, the method 300 includes setting a time duration of the animation. For example, referring to FIG. 1G, the object animation system 200 sets a time duration for the breakdancing animation 92c based on a time duration of a current song that is playing. In some implementations, the method 300 includes setting a frame rate of the animation based on the value. For example, the device changes a smoothness of a visual motion defined by the animation based on the value. In some implementations, the method 300 includes setting an easing factor for the animation. For example, the device sets an acceleration and/or a deceleration of the virtual object's movement based on the value. Setting a numerical parameter, such as the speed of the animation, based on API data improves device functionality by allowing the device to dynamically adjust animations to real-world conditions thereby ensuring that the presentation of the virtual object is contextually relevant and responsive.

As represented by block 330b, in some implementations, the method 300 includes determining that the first API includes a weather API and that the value obtained from the weather API indicates a weather condition. The device animates the virtual object based on the weather condition indicated by the value. For example, referring to FIG. 1E, when the weather data 54 indicates a sunny condition, the object animation system 200 performs the hat wearing animation 82g in order to provide an appearance that the virtual character 70 is putting on the virtual hat 74. As another example, when the value includes a temperature value that is greater than a threshold temperature, the device applies a fanning animation to the virtual object in order to provide an appearance that the virtual object is fanning itself. As another example, when the value indicates a rainy condition (e.g., the fourth weather condition 80d or the fifth weather condition 80e), the virtual object opens an umbrella (e.g., the fifth animation 82e) or jumps in a puddle. Animating a virtual object based on weather API data enables the device to deliver contextually relevant and immersive visual experiences that reflect real-time environmental conditions.

As represented by block 330c, in some implementations, the method 300 includes determining that the first API includes a location API and that the value obtained from the location API indicates a geographical location of the device. The device animates the virtual object based on the geographical location indicated by the value. For example, when the geographical location corresponds to an urban environment, the device animates the virtual object to mimic traffic behavior such as waiting at a crosswalk. As another example, when the geographical location corresponds to a rural environment, the device animates the virtual object to interact with wildlife by mimicking a bird's call. Animating a virtual object based on location API data enables the device to dynamically adapt the virtual content to the user's current geographical context thereby enhancing relevance and personalization of the virtual content.

As represented by block 330d, in some implementations, the method 300 includes determining that the first API includes a music API and that the value obtained from the music API indicates the music currently playing. The device animates the virtual object based on the music currently playing. For example, as shown in FIG. 1F, the device animates the virtual object to perform ballet moves for classical music, swing dancing for jazz music, popping, locking and breaking for pop music, or line dancing for country music. Animating a virtual object based on music API data provides the technical advantage of synchronizing visual content with audio inputs thereby creating a cohesive and immersive user experience. Animating the virtual object based on currently playing music allows the device to adjust animations in real-time to match the rhythm, tempo, or genre of the music thereby enhancing user engagement while efficiently utilizing computational resources by only rendering animations that are relevant to the current audio context.

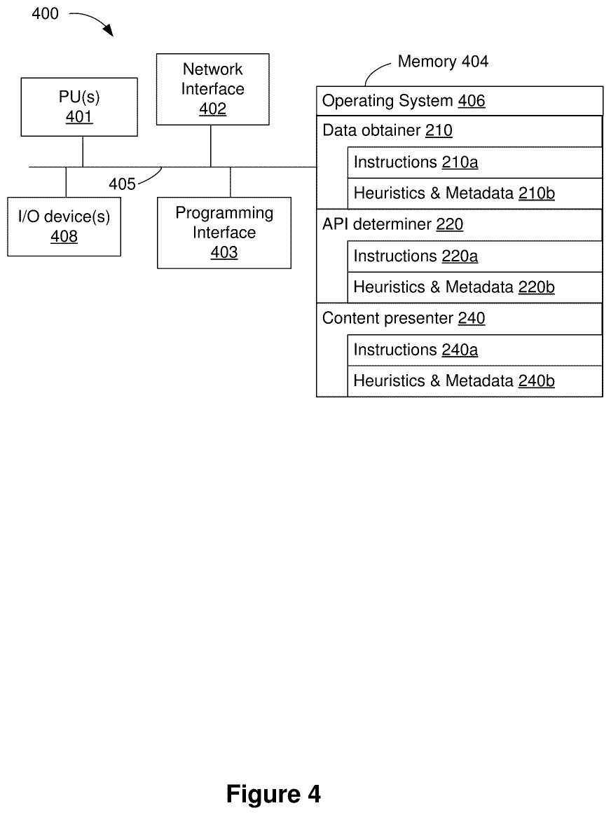

FIG. 4 is a block diagram of a device 400 in accordance with some implementations. In some implementations, the device 400 implements the device 20 shown in FIGS. 1A-2 and/or the object animation system 200 shown in FIGS. 1A-2. While certain specific features are illustrated, those of ordinary skill in the art will appreciate from the present disclosure that various other features have not been illustrated for the sake of brevity, and so as not to obscure more pertinent aspects of the implementations disclosed herein. To that end, as a non-limiting example, in some implementations the device 400 includes one or more processing units (PUs) 401, a network interface 402, a programming interface 403, a memory 404, one or more input/output (I/O) devices 408, and one or more communication buses 405 for interconnecting these and various other components.

In some implementations, the PU(s) 401 includes one or more central processing units (CPU(s)), one or more graphics processing units (GPU(s)) and/or one or more neural processing units (NPU(s)).

In some implementations, the network interface 402 is provided to, among other uses, establish and maintain a metadata tunnel between a cloud hosted network management system and at least one private network including one or more compliant devices. In some implementations, the one or more communication buses 405 include circuitry that interconnects and controls communications between system components. The memory 404 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. The memory 404 optionally includes one or more storage devices remotely located from the one or more PUs 401. The memory 404 comprises a non-transitory computer readable storage medium.

In some implementations, the memory 404 or the non-transitory computer readable storage medium of the memory 404 stores the following programs, modules and data structures, or a subset thereof including an optional operating system 406, the data obtainer 210, the API determiner 220 and the content presenter 240. In various implementations, the device 400 performs the method 300 shown in FIG. 3.

In some implementations, the data obtainer 210 includes instructions 210a, and heuristics and metadata 210b for obtaining data (e.g., a virtual object such as the virtual tower 40 shown in FIG. 1A, the virtual character 70 shown in FIG. 1C and/or the virtual object 212 shown in FIG. 2). In some implementations, the data obtainer 210 performs at least some of the operation(s) represented by block 310 in FIG. 3.

In some implementations, the API determiner 220 includes instructions 220a, and heuristics and metadata 220b for determining that the virtual object can be animated based on data provided by an API (e.g., for identifying the selected API(s) 232a shown in FIG. 2). In some implementations, the API determiner 220 performs at least some of the operation(s) represented by block 320 in FIG. 3.

In some implementations, the content presenter 240 includes instructions 240a, and heuristics and metadata 240b for displaying the animation of the virtual object (e.g., for displaying the selected animation(s) 252a shown in FIG. 2). In some implementations, the content presenter 240 performs at least some of the operation(s) represented by block 330 in FIG. 3.

In some implementations, the one or more I/O devices 408 include a set of one or more sensors for capturing sensor data that is provided by APIs. For example, the one or more I/O devices 408 include a location sensor for capturing the location data 56 shown in FIG. 1C, an ALS for capturing ambient light data, a microphone for capturing audio data, an IMU for capturing IMU data and/or an eye tracker for capturing gaze data. In some implementations, the one or more I/O devices 408 include a receiver for receiving the API data from another device (e.g., for receiving the weather data 54 shown in FIG. 1B from a weather service).

In various implementations, the one or more I/O devices 408 include a video pass-through display which displays at least a portion of a physical environment surrounding the device 400 as an image captured by the camera. In various implementations, the one or more I/O devices 408 include an optical see-through display which is at least partially transparent and passes light emitted by or reflected off the physical environment.

It will be appreciated that FIG. 4 is intended as a functional description of the various features which may be present in a particular implementation as opposed to a structural schematic of the implementations described herein. As recognized by those of ordinary skill in the art, items shown separately could be combined and some items could be separated. For example, some functional blocks shown separately in FIG. 4 could be implemented as a single block, and the various functions of single functional blocks could be implemented by one or more functional blocks in various implementations. The actual number of blocks and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

What is claimed is:

1. A method comprising:
at a device including a non-transitory memory, a display and one or more processors:
obtaining a virtual object that is animatable;
determining that an animation of the virtual object is a function of a value obtained from a first application programming interface (API) of a plurality of APIs available at the device; and
displaying the animation of the virtual object in accordance with the value obtained from the first API.

2. The method of claim 1, wherein a numerical parameter of the animation is a function of the value obtained from the first API.

3. The method of claim 2, wherein the numerical parameter includes a speed of the animation.

4. The method of claim 2, wherein the numerical parameter includes a time duration of the animation.

5. The method of claim 1, wherein the first API includes a weather API and the value indicates a weather condition, and the virtual object is animated based on the weather condition indicated by the value.

6. The method of claim 1, wherein the first API includes a location API and the value indicates a geographical location of the device, and the virtual object is animated based on the geographical location indicated by the value.

7. The method of claim 1, wherein the first API includes a music API and the value indicates music currently playing, and the virtual object is animated based on the music currently playing.

8. The method of claim 1, wherein the virtual object identifies the first API.

9. The method of claim 1, wherein the device automatically identifies the first API by:
identifying a characteristic of the virtual object;
determining a type of data associated with changing the characteristic; and
determining that the first API provides the type of data associated with changing the characteristic of the virtual object.

10. The method of claim 1, further comprising selecting the animation from a plurality of animations based on the value obtained from the first API.

11. The method of claim 1, wherein the virtual object includes a plurality of portions including a first portion and a second portion, wherein the first portion is animatable and the second portion is not animatable.

12. The method of claim 11, wherein a content creator that created the virtual object identifies the first portion as being animatable and the second portion as not being animatable.

13. The method of claim 11, wherein the device automatically determines that the first portion is animatable as a result of being connected with a body of the virtual object with a moving joint.

14. The method of claim 1, wherein the virtual object represents a physical object.

15. The method of claim 14, wherein the device is located at a first location and the physical object is located at a second location that is different from the first location; and
wherein the value obtained from the first API is associated with the second location.

16. A device comprising:
a display;
one or more processors;
a non-transitory memory; and
one or more programs stored in the non-transitory memory, which, when executed by the one or more processors, cause the device to:
obtain a virtual object that is animatable;
determine that an animation of the virtual object is a function of a value obtained from a first application programming interface (API) of a plurality of APIs available at the device; and
display the animation of the virtual object in accordance with the value obtained from the first API.

17. The device of claim 16, wherein the virtual object identifies the first API.

18. The device of claim 16, wherein the device automatically identifies the first API by:
identifying a characteristic of the virtual object;
determining a type of data associated with changing the characteristic; and
determining that the first API provides the type of data associated with changing the characteristic of the virtual object.

19. The device of claim 1, wherein the one or more programs further cause the device to select the animation from a plurality of animations based on the value obtained from the first API.

20. A non-transitory memory storing one or more programs, which, when executed by one or more processors of a device including a display cause the device to:
obtain a virtual object that is animatable;
determine that an animation of the virtual object is a function of a value obtained from a first application programming interface (API) of a plurality of APIs available at the device; and
display the animation of the virtual object in accordance with the value obtained from the first API.
